(19) United States
(12) Patent Application Publication
(10) Pub. No.: US 2019/0086227 A1
(43) Pub. Date: Mar. 21, 2019

(54) A Method, Apparatus, Computer Program for Providing Point of Interest Invitations

(71) Applicant: Nokia Technologies Oy, Espoo (FI)

(72) Inventors: Lasse Laaksonen, Tampere (FI); Miikka Vilermo, Siuro (FI); Arto Lehtiniemi, Lempäälä (FI); Mikko Tammi, Tampere (FI)

(21) Appl. No.: 15/534,138

(22) PCT Filed: Dec. 15, 2014
(86) PCT No.: PCT/FI2014/050999

§ 371 Date: Jun. 8, 2017

(51) Int. Cl. G01C 21/36; H04W 4/024

(52) U.S. Cl. CPC G01C 21/3682; G01C 21/3438; H04W 4/024; G01C 21/362

(57) ABSTRACT

The invention relates to a method that comprises creating a navigation point of interest, determining duration and a navigation area for the point of interest, transmitting a point of interest invitation to contacts within the navigation area, creating at least one linked point of interest comprising a linked navigation area determined on the basis of information relating to transportation method to the point of interest, and transmitting a linked point of interest invitation to contacts within the linked navigation area. The invention further relates to an apparatus and a computer program product for performing the method.

### BACKGROUND

Current electronic user devices, such as mobile devices, and their methods and applications relating to social communication are used to an increasing extent to inform and advertise events, meetings, or the like for contacts of social networks. On the basis of received information the contacts may decide if they are able to or if they want to participate to those events.

### SUMMARY

Now there has been invented an improved method and technical equipment implementing the method. Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect, there is provided a method, comprising creating a navigation point of interest, determining duration and a navigation area for the created point of interest, transmitting a point of interest invitation to contacts within the navigation area, creating at least one linked point of interest comprising a linked navigation area determined on the basis of information relating to transportation method to the point of interest, transmitting a linked point of interest invitation to contacts within the linked navigation area.

According to an embodiment, the point of interest invitation comprises navigation instructions to the point of interest. According to an embodiment, the linked point of interest invitation comprises navigation instructions relating to transportation method to the point of interest or navigation instructions to the point of interest. According to an embodiment, navigation instructions are automatically shown on a display of a device using navigation application. According to an embodiment, the created point of interest is a moving point of interest and wherein navigation area moves along with the moving point of interest. According to an embodiment, information relating to the transportation method is received from contacts that received the point of interest invitation. According to an embodiment, information relating to the transportation method is provided automatically from available public transportation information.

According to an embodiment, duration of point of interest increases when the navigation area increases. According to an embodiment, at least the one of the duration of point of interest and the area of the navigation area decreases by time. According to an embodiment, the apparatus is a mobile device.

According to a second aspect, there is provided an apparatus comprising at least one processor, memory including computer program code, the memory and the computer program code configured to, with the at least one processor, cause the apparatus to perform at least the following: create a navigation point of interest, determine duration and a navigation area for the created point of interest, transmit a point of interest invitation to contacts within the navigation area, create at least one linked point of interest comprising a linked navigation area determined on the basis of information relating to transportation method to the point of interest, and transmit a linked point of interest invitation to contacts within the linked navigation area.

According to an embodiment, the point of interest invitation comprises navigation instructions to the point of interest. According to an embodiment, the linked point of interest invitation comprises navigation instructions relating to transportation method to the point of interest or navigation instructions to the point of interest. According to an embodiment, navigation instructions are automatically shown on a display of a device using navigation application. According to an embodiment, the created point of interest is a moving point of interest and wherein navigation area moves along with the moving point of interest. According to an embodiment, information relating to the transportation method is received from contacts that received the point of interest invitation. According to an embodiment, information relating to the transportation method is provided automatically from available public transportation information. According to an embodiment, duration of point of interest increases when the navigation area increases. According to an embodiment, at least the one of the duration of point of interest and the area of the navigation area decreases by time.

According to a third aspect, there is provided an apparatus comprising means for creating a navigation point of interest, means for determining duration and a navigation area for the created point of interest, means for transmitting a point of interest invitation to contacts within the navigation area, means for creating at least one linked point of interest comprising a linked navigation area determined on the basis of information relating to transportation method to the point of interest, and means for transmitting a linked point of interest invitation to contacts within the linked navigation area.

According to a fourth aspect, there is provided a computer program product embodied on a non-transitory computer readable medium, comprising computer program code configured to, when executed on at least one processor, cause an apparatus to create a navigation point of interest, determine duration and a navigation area for the created point of interest, transmit a point of interest invitation to contacts within the navigation area, create at least one linked point of interest comprising a linked navigation area determined on the basis of information relating to transportation method to the point of interest, and transmit a linked point of interest invitation to contacts within the linked navigation area.

According to an embodiment, the point of interest invitation comprises navigation instructions to the point of interest. According to an embodiment, the linked point of interest invitation comprises navigation instructions relating to transportation method to the point of interest or navigation instructions to the point of interest. According to an embodiment, navigation instructions are automatically shown on a display of a device using navigation application. According to an embodiment, the created point of interest is a moving point of interest and wherein navigation area moves along with the moving point of interest. According to an embodiment, information relating to the transportation method is received from contacts that received the point of interest invitation. According to an embodiment, information relating to the transportation method is provided automatically from available public transportation information. According to an embodiment, duration of point of interest increases when the navigation area increases. According to an embodiment, at least the one of the duration of point of interest and the area of the navigation area decreases by time. According to an embodiment, the apparatus is a mobile device.

### DESCRIPTION OF THE DRAWINGS

In the following, various embodiments of the invention will be described in more detail with reference to the appended drawings, in which

FIG. 1 shows an apparatus according to an example embodiment;

FIG. 2 shows a layout of an apparatus according to an example embodiment;

FIG. 3 shows a user interface example of determining duration for a POI event according to an embodiment;

FIG. 4 shows an example of determining duration for a POI event according to an embodiment;

FIG. 5 shows an example of a navigator instruction of a POI event according to an embodiment;

FIG. 6 shows an example of navigation areas of a predictive POI event according to an embodiment;

FIG. 7 shows an example of navigation areas of a predictive POI event according to an embodiment;

FIG. 8 shows an example of navigation areas of a predictive POI event according to an embodiment;

FIG. 9 shows an example of navigator instructions of a predictive POI event according to an embodiment;

FIGS. 10a, b show an example of a split POI event according to an embodiment;

FIG. 11 shows an example of linked navigation areas of a POI event according to an embodiment; and

FIG. 12 shows a POI event determining method according to an embodiment of the invention.

### DESCRIPTION OF EXAMPLE EMBODIMENTS

Managing an event or a meeting may often require a large amount of work and planning on the part of an event organizer i.e. an inviter. In addition, invitees of the event or meeting may need to communicate with each other in order to agree carpooling, share transportation, or other common traveling plan to the event or meeting. The finding of a fellow traveler may even influence the decision whether or not the invitee decides to participate in an event or meeting. Moreover, it may often be more difficult to invite people to an event while the event is ongoing. In those cases the decision whether or not to participate has to be made quickly. Therefore meaningful information relating to the event or the meeting itself, but also information relating to possibilities to utilize other invitee(s) company and/or means of transport to travel to the event or meeting may be important for invitees.

It is an aim of the present invention to provide a method, a computer program product and a system as well as a mobile device, in which a user may define a dynamic navigation point of interest (POI) i.e. a location, for example, themselves or a meeting place, for an activity such as a meeting. A POI event may be, for example, a time period at a POI, such as a meeting in a certain place, or it may be, for example, a point of time in a POI, such as a passing-by car pool. The availability of the POI may be defined at least in part by a duration and/or distance of the POI set by the user. The POI is available inside a navigation area. The user may further define a purpose for the POI event. In some embodiments, other aspects such as the method of transportation may also be used to define the availability of the POI. At least the purpose, location, and duration of said POI event may change dynamically. The defined POI event may be transmitted as a so-called POI invitation comprising at least navigation instructions to the POI for a desired group of people inside a navigation area of the POI. The desired group of people may refer in this context to any type of contact(s) of the user in any environment, for example, contact lists stored in user's devices, for example, a contact list of friends or co-workers or relatives, or it may refer to contacts in some social network of any kind. The user may restrict people to be invited, for example, so that only contacts of certain type of social contacts, for example, co-workers or contacts of a certain social media application are invited. In other words, the inviting user may define people arranged to be notified about a POI event i.e. people for whom POI invitations are arranged to be transmitted if they are inside the navigation area.

The transmitted POI invitation may be presented i.e. shown as navigation instructions in a navigation application of a device of invited people or by some other way, for example, on a display of a device of invited people so that they are notified about the event and may, for example open navigation or other map application in order to receive navigation instructions to that POI. The transmitted POI invitation may also automatically launch showing of navigation instructions, for example, on a display view of a car navigator, an augmented reality glasses or some other device. In other words, user may not need open any application or react to the POI invitation, non-intrusive navigation may state automatically.

In addition, the inviter arranging to notify about a POI may only notify those contacts of his that are close enough to the POI i.e. inside the navigation area determined by determining a distance from the POI or by determining duration of the POI event. The inviter may determine a distance such that a desired number of his contacts are at such a distance (inside the navigation area) that they can reach the POI, before the POI event is over i.e. before it expires and transmit the POI invitation to them. Alternatively the inviter may determine duration of a POI such that a desired number of people (inviter's contacts) can reach the POI, before the POI event is over and transmit the POI invitation to them. The inviter's device may further monitor the situation and invite more people (inviter's contacts) if they arrive at such a distance from the POI that they may reach the POI event before it expires. Whether or not the invited people may reach the POI before it expires may depend on their current method of transportation, for example, their current speed.

It is also possible that the inviting user (inviter) notifies about a POI i.e. transmits a POI invitation to a large group of people or to all his contacts. Then, the device or system of each notified people i.e. invitees determines if the invitee (devices) is at such a distance from the POI that he/she can reach the POI, before the POI event expires. If the device or system determines that the distance is such that the POI can be reached, the device may display the POI invitation. The device of an invitee or the system may further monitor the situation and display the invitation, if the invitee arrives in such a distance from the POI that he can reach the POI event before it expires.

However, action(s) of another or other invitee(s) may affect the displaying of a POI invitation or transmitting a POI invitation. For example, if at least one other invitee confirms his attendance in the POI event for the system according to an embodiment of the invention i.e. invitee enrolls in the POI event, the system may determine or the enrolled invitee may notify the system that he arrives from a greater distance and at a higher speed. The system or device(s) connected to the system may determine that after that confirmation i.e. enrollment also at least one other person (contact), not invited yet, may reach the POI before it expires if he/they travel with the enrolled invitee, for example, by his car or by bus with him. Therefore the system may notify that one other person about the POI. In other words, a first person may invite people who can reach the POI before it expires with their current method of transportation and with their current speed. Invited second person from a greater distance traveling at a higher speed creates a linked navigation area for people traveling at a slower speed, when he enrolls in POI. People within that linked navigation area of invitation traveling at a slower speed may be directed or instructed to share the faster method of transportation with the second person traveling at a higher speed. However, in some embodiments the route and/or the current speed of the invitee, for example, towards the POI may be considered as an enrollment to the POI. For example, if the invitee proceeds along a certain route at a certain speed, it may be assumed that he uses a certain bus. And on the basis of this, the system may create a linked navigation area and notify, for example, by navigation instructions, people around the route of that bus i.e. inside the linked navigation area. It is also possible that the system determines possible transport means automatically or when instructed to do so and makes one or more linked navigation areas for the navigation area of the original POI event.

Therefore, a system, an apparatus, a computer readable medium, and a method according to embodiments provide a dynamic pull navigation system and a method enabling management of events, notifying invitees and instructing invitee to events, before the event and during the event. The system and method enable inviting of people having the opportunity, for example, suitable travelling means, to participate in the POI event. Further, the system and method enable inviting of contacts who don't have suitable travelling means at first, but whose travelling possibilities change after one or more invitees have enrolled in the event. Change of travelling possibilities may mean in this context, for example, possibility for a shared car ride or common traveling by public transport, when one or more enrolled invitee(s) indicated/determined using of those travelling means. The enrollment of at least one invitee may form a so-called linked POI event comprising a linked navigation area for the POI event. Contacts in that area may now get a linked POI invitation comprising indication or instruction(s) about suitable transport to the POI event and/or navigation instruction to the POI.

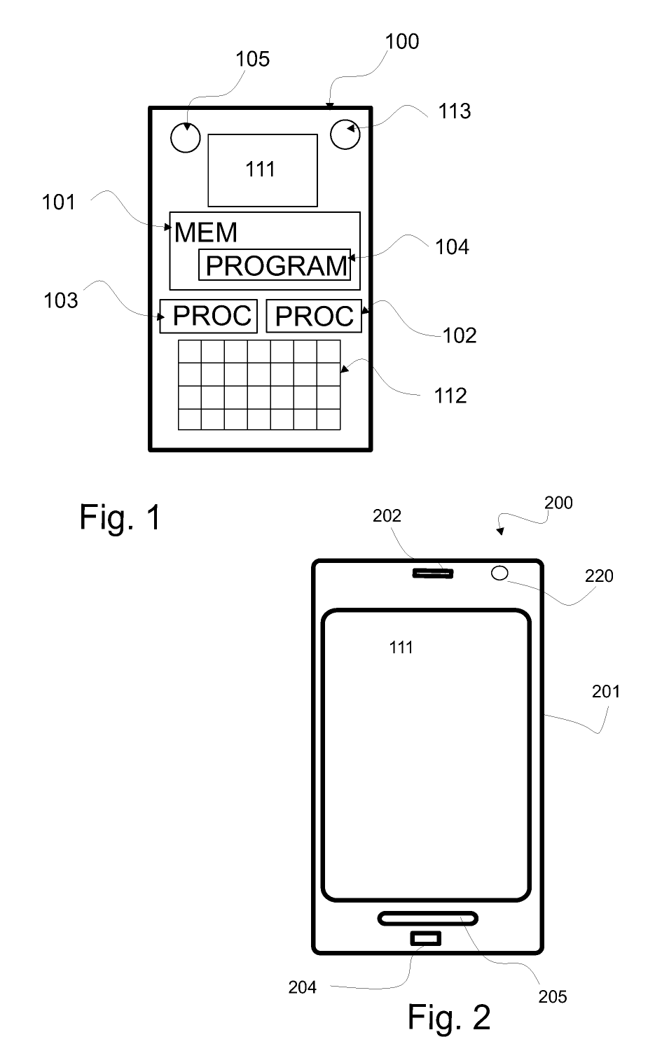

An example embodiment of the present invention and its potential advantages are understood by referring to FIGS. 1 through 12 of the drawings.

FIG. 1 shows an apparatus according to an example embodiment. The apparatus 100 contains required electronics and circuitry, for example, for a dynamic pull navigation method according to embodiments of the invention, wherein the dynamic pull navigation method is implemented as an additional function for the device 100. It should be understood, however, that the device 100 as illustrated and hereinafter described is merely illustrative of one type of device that may benefit from various embodiments, and therefore should not be taken to limit the scope of the embodiments. As such, it should be appreciated that at least some of the components described below in connection with the device 100 may be optional and thus, in an example embodiment may include more, less or different components than those described in connection with the example embodiment of FIG. 1.

The apparatus comprises a memory 101, at least one processor 102 and 103, and computer program code 104 residing in the memory 101. The apparatus 100 may further comprise one or more displays 111. The apparatus 100 may also comprise an interface means (e.g. a user interface) which allows a user to interact with the apparatus 100. The user interface means may be implemented by using one or more of the following: the display 111, a keypad 112, or other structures. The apparatus further comprises navigation means 105, for example, an electronic navigation system, block or circuitry which combines a positioning capability (such as GPS) and navigation functions. The navigation means 105 may comprise maps, which may be displayed in human readable format via text or in a graphical format in the display 111. The navigation means 105 may further determine apparatus location or current speed via sensors, maps, or information from external sources. Further, the navigation means 105 may provide directions to a POI event via text or speech or by using a map or maps, provide information on nearby devices of contacts and provide information on public transportation and traffic conditions. The apparatus 100 may further be configured to connect to another device e.g. by means of a communication means 113, a communication block, to receive and/or transmit invitations and other information, for example information relating to a GPS data through a wireless or wired network. The apparatus may further comprise other sensors or means arranged to produce or collect information relating to apparatus in question, for example, an acceleration transducer and a navigating means, such as a navigator, or receiving information relating to other devices, for example, devices of contacts, for example, their status information or location. The apparatus may further comprise means for indicating its own and/or one or more contacts' location, for example, GPS location and status information of one or more contacts' devices. The status information may comprise information, for example, about travelling alternatives i.e. the apparatus/devices may indicate their user's travel options that are possible and their current action. This status information may enable transmitting POI invitations to wider navigation area around a POI or showing of a POI invitation further away from a POI, even if the invited user is not currently using a fast travelling means, e.g. a car or the like.

FIG. 2 shows a layout of an apparatus according to an example embodiment. The apparatus 200 is a smart phone, but it may as well be any other suitable mobile device, for example, a mobile phone, a camera device, a tablet device, a head-mounted display, a near-eye display, a navigator or other GPS device comprising suitable means for communicating with contacts. Embodiments of the invention may also be implemented within any other electronic device or apparatus such as a personal computer and a laptop computer comprising suitable locating means and communication means.

The apparatus 200 shown in FIG. 2 comprises a housing 201 for incorporating and protecting the apparatus. The apparatus 200 may further comprise an audio input means 204 and/or an audio output means, which in embodiments of the invention may be any one of: an earpiece 202, a speaker of an analogue audio or analogue output connection or digital audio output connection suitable to produce audio signal, for example, navigation instructions. The apparatus 200 may further comprise a display 111, for example, in the form of e.g. a liquid crystal display. In other embodiments of the invention, the display may be any suitable display technology suitable to display, for example, maps and/or other navigation application data, an image or video. The apparatus 200 may further comprise a keypad 205 or other data input means. In other embodiments of the invention any suitable data or user interface mechanism may be employed. For example, the user interface may be implemented as a virtual keyboard or data entry system as part of a touch-sensitive display. The apparatus 200 according to an embodiment may also comprise an infrared port for short range line of sight communication to other devices. In other embodiments, the apparatus 200 may further comprise telecommunication means, in addition to the communication means 113, suitable for forming a phone connection to other device(s). In other embodiments, the apparatus 200 may further comprise any suitable short range communication solution such as, for example, a Bluetooth wireless connection, Near Field Communication (NFC) connection or a USB/firewire wired connection (not shown).

Apparatuses according to embodiment of the invention may be used for defining POI events. A defined point of interest (POI) event typically has a purpose or a description defining the event, duration (a starting time and an ending time), a location, an area for triggering the pull navigation (an area inside which a POI invitation is transmitted and navigation instructions are displayed), and a scope/definition for invitees (a list of invitees). Table 1 discloses an example of POI event properties i.e. elements. Not all elements of the POI event need be explicitly set, for example, a POI event may be created to start immediately upon creation, or it can be created for a certain time frame in the future with no given location, when location of the POI event may depend on the location of, for example, the inviter at given starting time of the POI event.

POI event name

Owner
Description
Duration
Location
Navigation area
Invitees

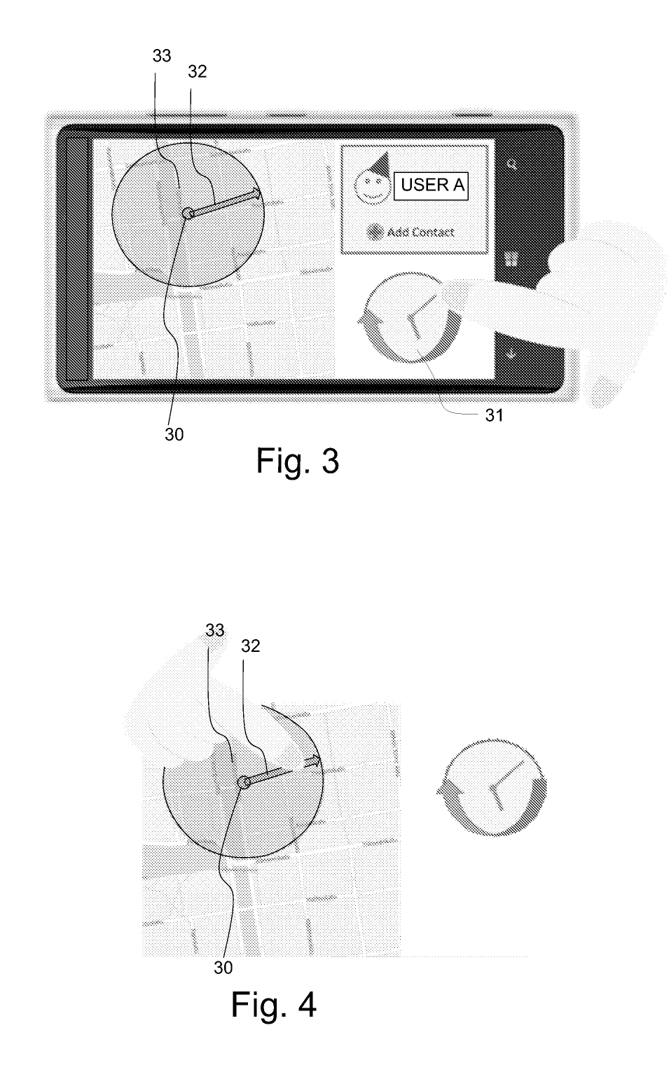

FIG. 3 shows a user interface (UI) example of determining duration for a POI event according to an embodiment. It is possible to invite contacts i.e. invitees, via a dynamic pull navigation request, POI invitation, for example, in the following way. User A is sitting in a pub, thinking it would be nice to see some of his friends. User A makes himself i.e. his current location 30 available as a navigation POI instead of sending regular invites directly to contacts. User A determines contacts, for example, from a connection list of a social network, for which the POI is intended, and chooses the time he is available at the given location i.e. at the POI. User A may define the duration of his availability at the current location i.e. the duration of the POI event. User A may determine the duration, for example, by a time setting block 31 of the UI, for example, by a finger or by numbers (not shown). When the duration increases, the distance from POI increases. Thus, this distance 32 determines the navigation area 33. Determined contacts inside the navigation area 33 may trigger showing of navigation instructions to them i.e. POI invitation will be transmitted to them. User A may get an indication that, for example, two of determined contacts are in the navigation area 33, and he may activate the navigation request i.e. POI invitation to them. Determined contacts that receive the invitation may be called as invitees. User A's contacts in the area 33 may then choose to follow the navigation instructions of the POI invitation towards the POI corresponding to User A's current location 30. In addition, the rest of the determined contacts may also follow the navigation instructions (they may also receive a POI invitation), if they enter the navigation area 33 that gradually gets smaller and smaller as time passes i.e. time of duration gets smaller, before the determined duration expires. Adjusting the time duration of the POI event is in this embodiment arranged to directly reflect in the distance coverage of the pull navigation i.e. to the navigation area 33.

However, it should be noted that in some embodiments a time duration of and a distance coverage may not be dependent on each other. User may define the area (distance coverage) and the time (duration) independently. The area may still get smaller as time passes. However area may firstly remain as initially set as long as it is still possible to reach the POI from said distance.

FIG. 4 illustrates an alternative example of how duration of a POI event may be defined. By increasing the distance 32 from a POI 30, the duration 31 will also increase. In other words, the navigation area 33 is increased by increasing distance 32. The duration of the POI event increases.

In some embodiments, the location of each contact or contacts of selected group of inviting user may appear on the map of a navigator UI. There may be different tiers of contacts. This feature may further be used to determine contact i.e. the group of invitees. When determining a contact to be reached by a POI notification, the inviting user may, as previously defined, increase the POI event duration such that a desired number of contacts can be reached by the navigation area. Or alternatively or in addition, the inviting user may adjust the navigation area so that a desired number of contacts can be reached. Once a desired or certain number of contacts are reachable, the pull navigation may be locked to only apply to these determined contacts. Therefore, further movement of original invitees in and out of the navigation area may not affect the availability of the POI event for newly emerging contacts. The system may, however, warn the inviter if one or more of the determined contacts i.e. invitees move away from the navigation area of the POI event to allow change of settings. The user may notify new contacts i.e. determine a new contact for the POI event, for example, by increasing the duration of the POI event. Similarly, the system may warn invitees who move away from the area of the POI event.

The pull navigation triggers on the devices of invitees. The POI event may appear in the navigation UI of an invitee directly as a suggested destination or as navigation instructions. For example, a car navigator with a HUD or a near-eye display for pedestrian may utilize an augmented reality (AR) feature to provide custom “road signs” automatically. An example of car navigator is shown in FIG. 5 with navigator instruction of a POI event. The navigator instruction is shown as a sign 50. The sign 50 may be a link to additional information of the POI event. There may be more signs than one or the navigation instruction is indicated by voice or by some other way. However, it is also possible that an invitee gets a different kind of notification indicating that a new time-constrained POI is available or that invitee gets more subtle POI invitation, for example, a hint about the new POI.

In a case of future POI event(s) i.e., ones that are not yet active, i.e. not ongoing or not starting soon, but will start later, for example, tomorrow, in one week or next month, the POI event may trigger a calendar note/invitation instead of POI invitation. The POI event may then trigger navigation instructions when the POI event is timely and the invitee is in the navigation area of the POI event.

Such a future POI event may also trigger secondary navigations for a preliminary POI event. For example, if attending a future POI event is most convenient by taking a train, going into vicinity of the train station (acting as a secondary navigation area in this example) may trigger secondary navigation, for example navigation instruction to the train station and instructions to purchase a train ticket. In other words, in this embodiment a secondary POI event is buying the train ticket. A direct link for an online purchase may also be offered. The primary POI event (previous future POI event) may then trigger navigation instructions when the primary POI event is timely and the invitee is in the navigation area of the primary POI event, wherein the navigation area may or may not include the train station area.

In some embodiments, a two-way communication may be implemented for attendance confirmation. In other words, in some embodiments the POI event may be arranged conditional. For example, User B may reserve 4 hours to enjoy the company of his co-workers i.e. he determines that duration of the POI event is 4 hours, but will not stay at the location of a POI event if no one shows up. He may give a confirmation period when any of the invitees may confirm attendance in the event; if one or more invitees confirms attendance, duration of POI event is 4 hours, otherwise the conditional POI event is cancelled (in a case of future POI event) or the conditional POI event lasts that confirmation period (on-going POI event). Therefore, in some embodiments, the inviting user, User B in the above mentioned example, may give a direct or indirect modification permission for the invitees to at least one of the parameters of the POI event. In this example, the parameter is duration.

The system may provide information for inviting user or invitees about POI events. Information may be, for example, displayed, for example, after the notification of the POI event has been made, and the information may include, for example, a number of invitees, a number of contacts that have confirmed their attendance, percentage of contacts that are approaching the POI event location, mean time of contacts to reach the location, etc.

It is also possible that in some embodiments, a transportation method is defined for a POI event by the inviter. The inviter may, for example, specify that the navigation instructions of a POI invitation are triggered only by foot or via public transportation. Devices of contacts may have status indicating current transportation method or the transportation method of contacts may be defined on the basis of the route and/or current speed of the contact. In some embodiments, the mode of transportation is instructed for the invitee. For example, a limited parking space may make it more convenient to reach a POI event using public transportation. In some embodiments, the associated cost of attending (at least in terms of transportation) may be provided as part of the navigation invite/instructions.

The POI event parameters may further change dynamically. According to an embodiment, there may exist a predictive POI event. Predictive POI events may be divided, for example, into two groups: the first group is modeled predictions, the second group is inviting user-generated predictions.

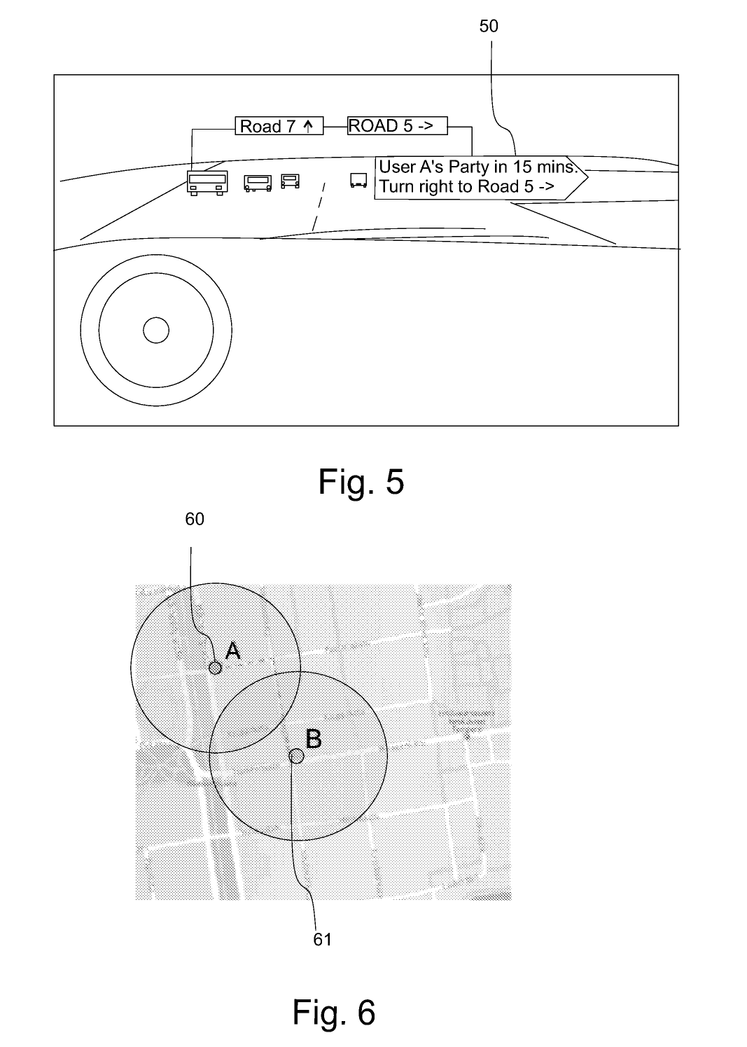

FIG. 6 shows an example of a modeled predictive POI event according to an embodiment, where an inviting user has added two locations for a predictive POI event, a primary location A 60 and a secondary location B 61. As the inviting user himself is at the primary location A 60, him being at the secondary location B 61 at a determined duration of the POI event may be considered a prediction. The service may dynamically adjust parameters based on what is currently happening. For example, when the inviting user moves from the location A 60 to the location B 61 during the determined duration of the POI event, at least one parameter of POI event may change. On the other hand, also on the basis of previous usage patterns of the inviting user, the secondary location may also be provided automatically for a POI event by the system. A new parameter, ‘probability’, may be added to the POI event definition.

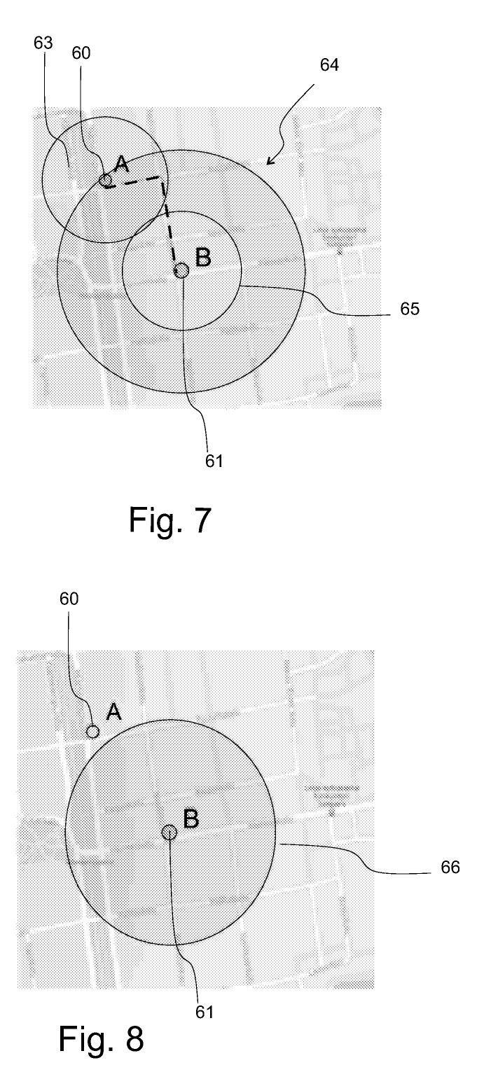

FIG. 7 shows changing of the modeled predictive POI of FIG. 6. A navigation area 63 around the primary location A 60 is decreasing. There is a two-tier area 64 around the secondary location reflecting the planned handover between the locations A 60 and B 61. Within the inner circle 65 of the two-tier area 64, the invitees heading for the secondary location B 61 may reach the location B 61 prior to start of the POI event at said secondary location B 61. Whereas, FIG. 8 shows the navigation area 66 around the secondary location B 61 of FIGS. 6 and 7 in a case where the location of the POI event has already changed to the secondary location B 61 from the primary location A 60 and when the primary location A 61 is not an active location of the POI event anymore.

Secondary location of POI may also be a so called linked navigation area, for example, in a case of carpool or shared public transportation.

Invited second person from a greater distance traveling at higher speed creates a cone of invitation i.e. a linked navigation area for people traveling at slower speed, when he enrolls to POI. People within that cone of invitation traveling at slower speed may be directed or instructed to share the faster method of transportation with the second person traveling at higher speed. However, in some embodiments route and/or current speed of the invitee, for example, towards the POI may be considered as an enrollment to the POI. For example, if the invitee proceeds along a certain route at a certain speed, it may be assumed that he uses a certain bus. And on the base of this, the system may create a cone of invitation and notify people around the route of that bus.

In addition to showing navigation information for invitees, the system may in some embodiments show navigation area(s) or linked navigation area(s) on a map.

The probability parameter may be used, for example, to classify or visualize navigation instructions in the car navigator UI. FIG. 9 presents an example of this. The first navigation instruction 91 indicates a primary location of a predictive POI and the second navigation instruction 92 indicates a secondary location of the predictive POI. The system may have predicted that User A's party event will continue at a Tshili's due to previous usage pattern(s) or the User A may have made a predictive POI event, comprising User A's party at a certain determined address as a primary location of the predictive POI event and subsequent meeting at Tshili's as a secondary location of the predictive POI event. For example, color coding, broken line or other marking may be used to indicate that the secondary location is a prediction.

POI events according to embodiments may further change to or be created as a nested POI event. A POI event is a nested POI event when a POI event is part of another POI event. POI events may also merge or split. In other words, at least two POI events may dynamically merge into one i.e. they may form a combined POI event. POI events may also dynamically split into at least two separate POI events. Splitting of POI events may be utilized, for example, in case of a predictive mode POI event, wherein, for example, the secondary location B 61 of the predictive POI event of FIG. 6 could be nested to occurrence at the primary location A 60 of the predictive POI event.

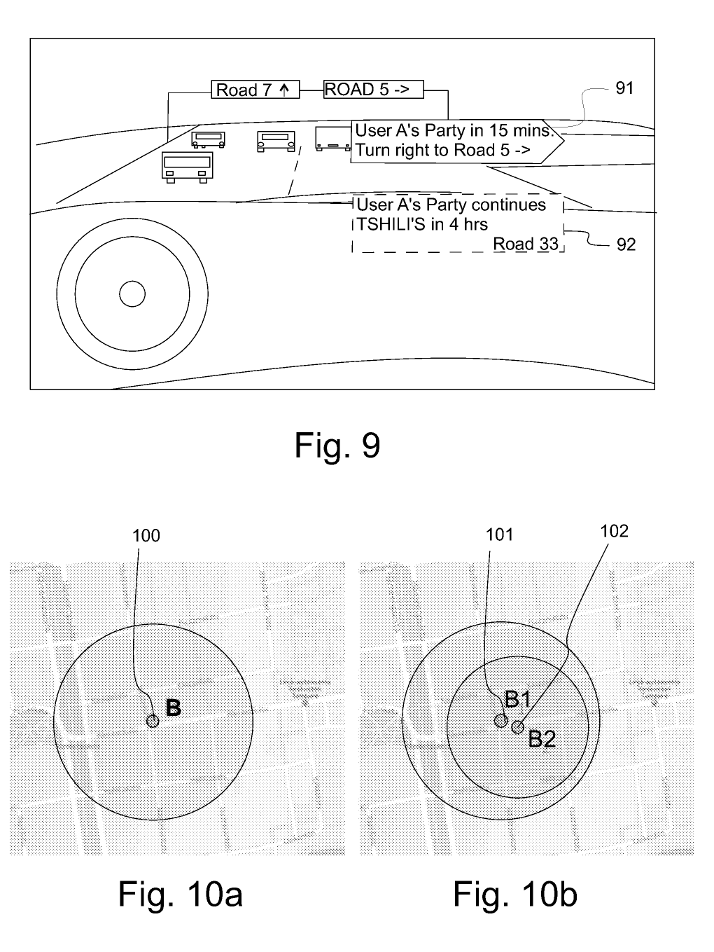

FIGS. 10a and b illustrate an example of a split of a POI event B 100 into two child events B1 and B2 according to an embodiment. In this example, some of the invitees (possibly including the inviter) of a POI event B 100 (shown in FIG. 10 a) decide to move to another location, but wish to remain available for the other invitees of the POI event B 100. The POI event B 100 is split into two separate child POI events. One child POI event may or may not inherit a number of parameters based on the primary POI event (POI event B 100 in this example). In this example the child POI event B1 101 has inherited all the parameters of the original event B 100 and added a link to the second child POI event B2 102. The second child POI event B2 102 may inherit most of the parameters from the original POI event B 100, but the parameters may be changeable. For example, in this example, duration time of the second child POI event B2 102 is shorter than duration time of the first child POI event B1 101 corresponding to the duration time of the POI event B 100.

Table 2 presents an extended list of POI event parameters.

POI event name

Owner
Description
Duration
Location
Navigation area
Invitees
Parent POI event
Child POI event
Linked POI event
Probability

Table 3 gives an example of an extended list of a POI event comprising examples for parameters or explanations for the use of the parameter.

| POI event name | Name or identifier |
|---|---|
| Owner | Creator of event: e.g., User A |
| Description | Purpose or description of event which may be |
| | indicated to invitees: e.g., Party |
| Duration | Starting and ending times: e.g., today at 14:00 and |
| | today at 17:30 |
| Location | Location of event: e.g. User A's location |
| Navigation area | Area in which pull navigation activates: e.g., a 3-km |
| | radius from User A's location |
| Invitees | A list of contacts etc. who are invited and for whom |
| | navigation is triggered: e.g., User A's friends |
| Parent POI event | Name or identifier of current event's parent event |
| Child POI event | Name(s) or identifier(s) of current event's child |
| | event(s) |
| Linked POI event | Name(s) or identifier(s) of event(s) linked to |
| | current event: e.g., User A's party event may be |
| | linked to User A's after-party dinner event (said |
| | event could alternatively be a child POI event) |
| Probability | Gives the probability of a predicted event |

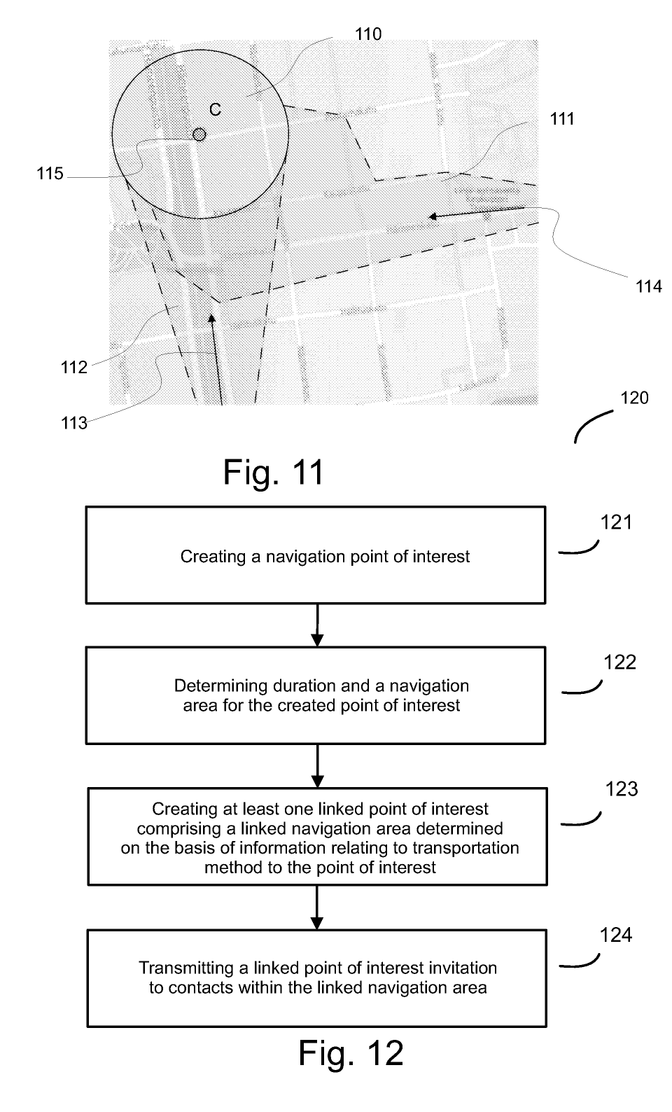

FIG. 11 shows an example of a POI event navigation area (solid line) 110 and navigation areas of linked POI events (broken line) i.e. linked navigation areas 111 and 112. Arrows 113 and 114 indicate the direction of travel inside linked navigation areas 111 and 112. Determined contacts within the POI event navigation area 110 have received POI invitations. And after two invitees have enrolled to the POI event, the system may create linked POI events comprising the linked navigation areas 111 and 112 formed around enrolled invitees travel routes. Alternatively, the system has determined possible travel routes or transportation methods to the POI, for example, on the basis of locations of determined contacts outside the navigation area 110, and created/determined linked POI events comprising the linked navigation areas 111 and 112 on the basis of those possible travel routes or transportation methods. Determined contacts inside the linked navigation areas 111 and 112, but outside the navigation area 110, may now also receive POI invitations. By linking POI events, for example linked POI events to preliminary/main POI event (110 in this example), but also the invitees with each other, it is possible to create a personalized invitation for each determined user/invitee.

A linked navigation area of a linked POI event may, for example, have a conical shape, wherein the conical shape (and the linked navigation area) broadens towards a navigation area of the POI event for which the linked POI event was created.

In FIG. 11, User in location C 115 makes a navigation POI. The invitees of User C's POI event receive navigation guidance when entering the navigation area 110. The system considers means such as public transportation and the whereabouts and mode of transportation of other invitees. The system may thus automatically search and provide information relating to possible transportation methods from available public transportation information. The system further creates two linked POI events, wherein linked POI may be considered to correspond to a secondary location of the predictive POI explained above. Linked POI events enlarge the total navigation area by the linked navigation areas 111 and 112. Determined contacts inside the linked navigation areas 111 and 112, but outside the navigation area 110, receive POI invitations. Invitees may now reach the POI event by first reaching the linked secondary POIs. For example some of User's friends may take a bus inside the linked navigation areas 111, while others observe a car (POI) approaching inside the linked navigation areas 112 and share a ride to the location C115 that is the POI of the main POI event.

It is also possible to create a moving POI event. It might be useful, if inviting user wants the invitees to follow him. For example, an inviting user driving a car sets himself up as a POI event and invites one or more contacts. A navigation area travels on the map and surrounds inviting user's car. Meanwhile Invitee A drives at close-by road. When cars are close enough, the road becomes part of the navigation area. Invitee A receives a POI invitation which may, for example, instruct the Invitee A to follow the inviting user to a location that is unknown to the Invitee A.

FIG. 12 shows a POI event determining method 120 according to an embodiment of the invention.

In the method 120, in step 121, a navigation point of interest is created. In step 122, duration and a navigation area for the created point of interest is determined. In step 123, a point of interest invitation is transmitted to contacts within the navigation area. In step 124, at least one linked point of interest comprising a linked navigation area determined on the basis of information relating to transportation method to the point of interest is created. In step 123, a linked point of interest invitation is transmitted to contacts within the linked navigation area.

Indication areas according to any embodiment may have any shape in addition to circular. The shape may depend on a POI, map, configuration of a system, selection of inviting user, settings of the system or inviting user's device or any other.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-30. (canceled)

31. A method, comprising:
creating a navigation point of interest;
determining duration and a navigation area for the created point of interest;
transmitting a point of interest invitation to contacts within the navigation area;
creating at least one linked point of interest comprising a linked navigation area determined on the basis of information relating to transportation method to the point of interest; and
transmitting a linked point of interest invitation to contacts within the linked navigation area.

32. A method according to claim 31, wherein the point of interest invitation comprises navigation instructions to the point of interest.

33. A method according to claim 31, wherein the linked point of interest invitation comprises navigation instructions relating to transportation method to the point of interest or navigation instructions to the point of interest.

34. A method according to claim 32, wherein navigation instructions are automatically shown on a display of a device using navigation application.

35. A method according to claim 31, wherein the created point of interest is a moving point of interest and wherein navigation area moves along with the moving point of interest.

36. A method according to claim 31, wherein information relating to the transportation method is received from contacts that received the point of interest invitation.

37. A method according to claim 31, wherein information relating to the transportation method is provided automatically from available public transportation information.

38. A method according to claim 31, wherein duration of point of interest increases when the navigation area increases.

39. A method according to claim 31, wherein at least the one of the duration of point of interest and the area of the navigation area decreases by time.

40. An apparatus comprising at least one processor, memory including computer program code, the memory and the computer program code configured to, with the at least one processor, cause the apparatus to perform at least the following:
create a navigation point of interest;
determine duration and a navigation area for the created point of interest;
transmit a point of interest invitation to contacts within the navigation area;
create at least one linked point of interest comprising a linked navigation area determined on the basis of information relating to transportation method to the point of interest; and
transmit a linked point of interest invitation to contacts within the linked navigation area.

41. An apparatus according to claim 40, wherein the point of interest invitation comprises navigation instructions to the point of interest.

42. An apparatus according to claim 40, wherein the linked point of interest invitation comprises navigation instructions relating to transportation method to the point of interest or navigation instructions to the point of interest.

43. An apparatus according to claim 41, wherein navigation instructions are automatically shown on a display of a device using navigation application.

44. An apparatus according to claim 40, wherein the created point of interest is a moving point of interest and wherein navigation area moves along with the moving point of interest.

45. An apparatus according to claim 40, wherein information relating to the transportation method is received from contacts who received the point of interest invitation.

46. An apparatus according to claim 40, wherein information relating to the transportation method is provided automatically from available public transportation information.

47. An apparatus according to claim 40, wherein duration of point of interest increases when the navigation area increases.

48. An apparatus according to claim 40, wherein at least the one of the duration of point of interest and the area of the navigation area decreases by time

49. An apparatus according to claim 40, wherein the apparatus is a mobile device.

50. A computer program product embodied on a non-transitory computer readable medium, comprising computer program code configured to, when executed on at least one processor, cause an apparatus to:
create a navigation point of interest;
determine duration and a navigation area for the created point of interest;
transmit a point of interest invitation to contacts within the navigation area;
create at least one linked point of interest comprising a linked navigation area determined on the basis of information relating to transportation method to the point of interest; and
transmit a linked point of interest invitation to contacts within the linked navigation area.
